(19) United States
(12) Patent Application Publication
(10) Pub. No.: US 2012/0124355 A1
(43) Pub. Date: May 17, 2012

(54) SINGLE VOLUME IMAGE FILE EXTRACTION

(76) Inventors: Sumant Kumar Patro, Fremont, CA (US); Varadaraj Talamacki, Fremont, CA (US); Vinu Velayudhan, Fremont, CA (US); Senthil Thangaraj, Fremont, CA (US)

(21) Appl. No.: 12/944,061

(22) Filed: Nov. 11, 2010

(51) Int. Cl. G06F 9/00

(52) U.S. Cl. 713/2

(57) ABSTRACT

Disclosed is a method of booting a virtual machine. A file, accessible by a privileged domain that includes an index file image and a plurality of other file images is stored. The index file image is of a predetermined, fixed size and includes a file name and a file size for each of the other images in the file. The privileged domain provides the file to one or more non-privileged virtual machines as a single disk image of the fixed size mounted on the non-privileged virtual machine. The other file images are extracted by the virtual machines based on the file names and file sizes stored in the index file image.

### BACKGROUND OF THE INVENTION

Virtual machines allow multiple operating systems to be run simultaneously on the same computer hardware. This allows the sharing of the underlying physical machine resources (e.g., memory, I/O, etc.) between multiple operating systems (or instances of the same operating system). Virtual machines facilitate application provisioning, maintenance, high availability, and disaster recovery. The software layer providing the virtualization is typically called a virtual machine monitor or hypervisor. A hypervisor may run on bare hardware, or on top of an operating system.

### SUMMARY OF THE INVENTION

An embodiment of the invention may therefore comprise A method of booting a virtual machine, comprising: storing a file accessible by a privileged domain, said file comprising a first file image and a plurality of file images, said first file image including a file name and a file size for each of said plurality of file images in said file; providing, by said privileged domain, said file to said virtual machine, said file provided to said virtual machine as a single disk image; and, extracting from said single disk image, by said virtual machine, said plurality of file images based on said file name and said file size for each of said plurality of file images.

An embodiment of the invention may therefore further comprise A method of providing a bootable image in RAM to a virtual machine, comprising: creating a file accessible file comprising a first fixed-size file image and a plurality of file images, said first fixed-size file image including a file name and a file size for each of said plurality of file images in said file; providing, by said privileged domain, as a ramdisk, said file to said virtual machine as a single disk image; and, extracting from said single disk image, by said virtual machine, said plurality of file images based on said file name and said file size for each of said plurality of file images.

### BRIEF DESCRIPTION OF THE DRAWINGS

FIG. 1 is a block diagram of multiple virtual machines running on a computer.

FIG. 2 is a flowchart of a method of providing a disk image to a virtual machine.

FIG. 3 is a flowchart of a method of extracting file from a disk image.

FIG. 4 is a block diagram of a computer.

### DETAILED DESCRIPTION OF THE EMBODIMENTS

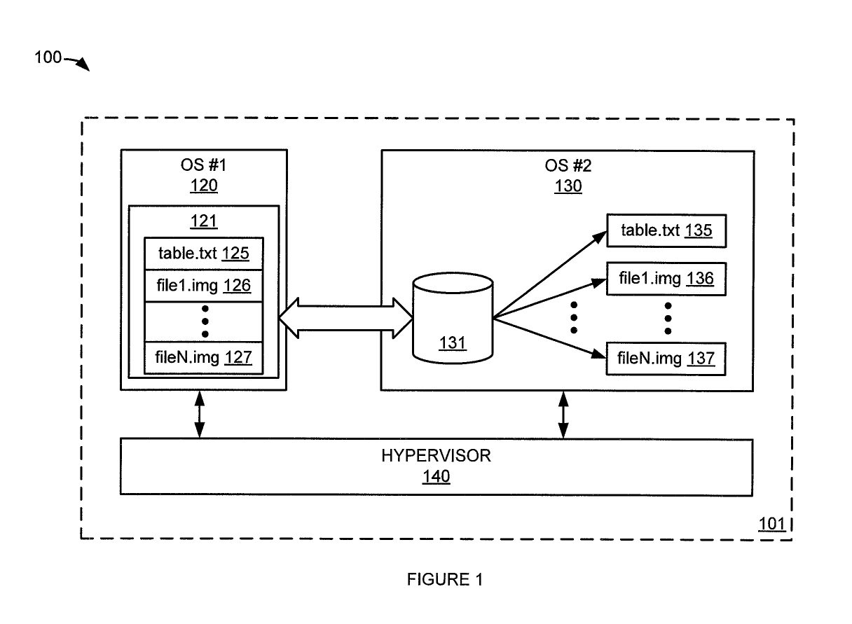

FIG. 1 is a block diagram of multiple virtual machines running on a computer. In FIG. 1, virtual machine system 100 comprises software running on computer 101. Software running on computer 100 comprises operating system #1 (OS #1) 120, operating system #2 (OS #2) 130, and hypervisor 140. Hypervisor 140 is operatively coupled to OS #1 120 and OS #2 130.

In an embodiment, OS #1 120 and OS #2 130 are running as virtual machines under the supervision of hypervisor 140. In an embodiment, hypervisor 140 is the Xen hypervisor. OS #1 120 and OS #2 130 may be any guest operating systems compatible with hypervisor 140. For example, OS #1 120 and/or OS #2 130 may be a Windows, Apple, UNIX, Linux, or FreeBSD based operating systems.

In an embodiment, OS #1 130 is running as a privileged virtual machine. The privileged virtual machine (or domain) may also be known as Domain 0 (Dom0). The privileged domain is the operating system virtual machine guest running on the hypervisor with direct hardware access and guest management responsibilities. OS #2 130 may be running or booting as an unprivileged domain guests (a.k.a., DomU). Unprivileged guests running on hypervisor 140 have no direct access to hardware (e.g. memory, disk, etc.).

In an embodiment, OS #1 120 includes, has access to, or creates an image file 121. This image file 121 includes a first file image 125 and a plurality of file images 126-127. The first file image 125 includes the file names and files sizes for each of the plurality of file images 126-127. The first file image 125 is a fixed-size (e.g., 512). Thus, a routine may extract the first file image 125 by copying a fixed number of bytes (i.e., 512) from image file 121. This allows the first file image to be extracted from image file 121 without using a size of the first file image 125 that is stored in the first file image 125. The first file image may optionally also include a checksum value for each of the file images 125-127 in image file 121.

OS #1 120 exposes image file 121 to OS #2 130 as a device. In particular, OS #1 120 may allow OS #2 130 to access image file 121 as a single disk image 131. That is, image file 121 will appear to OS #2 as a hardware (e.g., IDE) disk drive 131. OS #1 120 may expose image file 121 via an entry in a configuration file passed to hypervisor 140 mechanism of “creating” a new virtual machine. For example, for the Xen hypervisor, an entry in the configuration file for xm create may specify “disk =[‘fileihome/files.img,ioemu:hda,w’]. This would cause the file “files.img” which corresponds to image file 121 to appear to OS #2 130 as disk image 131.

OS #2 130 may extract the plurality of image file 126-127. OS #2 130, or a bootloader for OS #2, may extract the plurality of images files 126-127 from disk image 131 into a ramdisk in order to boot OS #2 130.

OS #2 130 extracts the first file image 125 into a first file 135 by copying the fixed-size number of bytes from disk image 131. OS #2 130 may then use the information (i.e., file name, file size, and checksum) for each of the plurality of file images 126-127 in image file 121 from disk image 131. For example, a file 136 may be extracted from disk image 131 by the Linux command “dd if=/dev/hda of=file1.img skip 512 count=89”. After extracting, OS #2 130 may compare the checksum stored in first file 135 with a checksum calculated on file 136. This process may be repeated for all of the file images in image file 121 (and by extension single disk image 131).

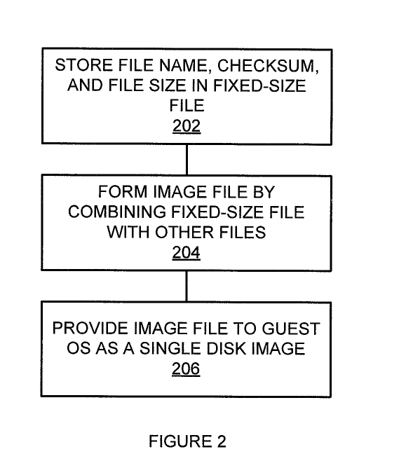

FIG. 2 is a flowchart of a method of providing a disk image to a virtual machine. The steps illustrated in FIG. 2 may be performed by one or more elements of virtual machine system 100. A file name, checksum, and file size are stored in a fixed-size file (202). For example, OS #1 120 may store, in a fixed-sized file (or a fixed-size file image 125) a file name, files size, and optionally a checksum for each of the files that correspond to the plurality of files images 126-127 stored in image file 121. An image file is formed by combining the fixed-size file with other files (204). For example, the fixed size file from block 202 may be combined with the files that correspond to the plurality of file images 126-127 to form image file 121. This may be performed by, for example, the Linux command “cat table.txt file1.img fileN.img>files.img”.

The image file is provided to a guest operating system as a single disk image (206). For example, image file 121 may be provided to OS #2 130 as a single disk image 131. For the Xen hypervisor, an entry in the configuration file for xm create may specify “disk=[‘file:/home/files.img,ioemu:hda,w’] or the like may be used to provide OS #2 with the contents of image file 121 as a single disk image 131.

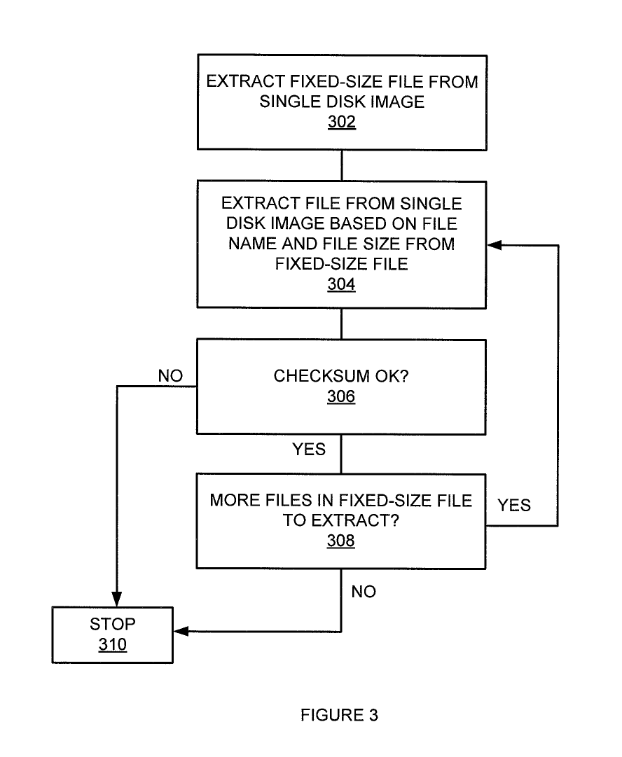

FIG. 3 is a flowchart of a method of extracting file from a disk image. The steps illustrated in FIG. 3 may be performed by one or more elements of virtual machine system 100. A fixed-size file is extracted from a single disk image (302). For example, fixed-size file 135 may be extracted from disk image 131. Fixed-size file 135 may be extracted from disk image 131 by the Linux command “dd if=/dev/hda of=table.txt count=1”. A file is extracted from the single disk image based on a file name and file size from the fixed-size file (304). For example, OS #2 130 may extract the file 136 from disk image 131 by copying a number of bytes from disk image 131. The file name, number of bytes, a the starting number of bytes, and/or a checksum may be received from the extracted fixed-size file 135.

A checksum is checked (306). For example, OS #2 130 may calculate a checksum for file 136 and compare it to a checksum stored in fixed-size file 135. If the stored and calculated checksums are not equal, flow stops in block 310. If the stored and calculated checksums are equal, flow proceeds to block 308. A check is made to determine if there are more files specified in the fixed size file that have not yet been extracted (308). If there are more files to be extracted, flow proceed to block 304 to continue to extract files from the single disk image. If there are no more files to extract, flow stops in block 310.

The systems, software, operating systems, hypervisors, and functions described above may be implemented with or executed by one or more computer systems. The methods described above may be stored on a computer readable medium. Many of the elements of virtual machine system 100 may be, comprise, or include computers systems. This includes, but is not limited to computer 101.

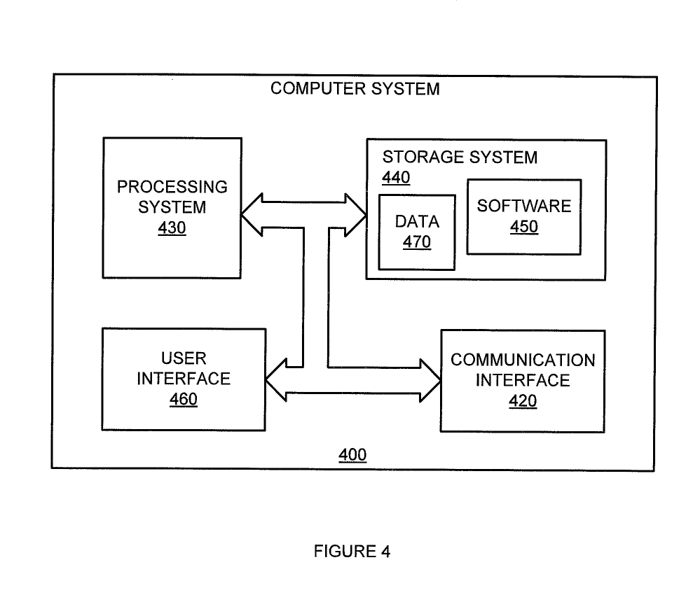

FIG. 4 illustrates a block diagram of a computer system. Computer system 400 includes communication interface 420, processing system 430, storage system 440, and user interface 460. Processing system 430 is operatively coupled to storage system 440. Storage system 440 stores software 450 and data 470. Processing system 430 is operatively coupled to communication interface 420 and user interface 460. Computer system 400 may comprise a programmed general-purpose computer. Computer system 400 may include a microprocessor. Computer system 400 may comprise programmable or special purpose circuitry. Computer system 400 may be distributed among multiple devices, processors, storage, and/or interfaces that together comprise elements 420-470.

Communication interface 420 may comprise a network interface, modem, port, bus, link, transceiver, or other communication device. Communication interface 420 may be distributed among multiple communication devices. Processing system 430 may comprise a microprocessor, microcontroller, logic circuit, or other processing device. Processing system 430 may be distributed among multiple processing devices. User interface 460 may comprise a keyboard, mouse, voice recognition interface, microphone and speakers, graphical display, touch screen, or other type of user interface device. User interface 460 may be distributed among multiple interface devices. Storage system 440 may comprise a disk, tape, integrated circuit, RAM, ROM, network storage, server, or other memory function. Storage system 440 may be a computer readable medium. Storage system 440 may be distributed among multiple memory devices.

Processing system 430 retrieves and executes software 450 from storage system 440. Processing system may retrieve and store data 470. Processing system may also retrieve and store data via communication interface 420. Processing system 450 may create or modify software 450 or data 470 to achieve a tangible result. Processing system may control communication interface 420 or user interface 470 to achieve a tangible result. Processing system may retrieve and execute remotely stored software via communication interface 420.

Software 450 and remotely stored software may comprise an operating system, utilities, drivers, networking software, and other software typically executed by a computer system. Software 450 may comprise an application program, applet, firmware, or other form of machine-readable processing instructions typically executed by a computer system. When executed by processing system 430, software 450 or remotely stored software may direct computer system 400 to operate as described herein.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of booting a virtual machine, comprising:
storing a file accessible by a privileged domain, said file comprising a first file image and a plurality of file images, said first file image including a file name and a file size for each of said plurality of file images in said file;
providing, by said privileged domain, said file to said virtual machine, said file provided to said virtual machine as a single disk image; and,
extracting from said single disk image, by said virtual machine, said plurality of file images based on said file name and said file size for each of said plurality of file images.

2. The method of claim 1, wherein said first file image is a predetermined size.

3. The method of claim 1, wherein said first file image includes, for each of said plurality of file images, a checksum.

4. The method of claim 1, further comprising:
for each of said plurality of file images, calculating a checksum.

5. The method claim 3, further comprising:
for each of said plurality of file images, comparing a calculated checksum with said checksum.

6. The method of claim 1, wherein said single disk image is stored in RAM.

7. A method of providing a bootable image in RAM to a virtual machine, comprising:
creating a file accessible file comprising a first fixed-size file image and a plurality of file images, said first fixed-size file image including a file name and a file size for each of said plurality of file images in said file;
providing, by said privileged domain, as a ramdisk, said file to said virtual machine as a single disk image; and,
extracting from said single disk image, by said virtual machine, said plurality of file images based on said file name and said file size for each of said plurality of file images.

8. The method of claim 7, further comprising:
Extracting from said single disk image, a first fixed-size file from said single disk image by reading a fixed-size number of bytes from said single disk image, said fixed-size number of bytes corresponding to the number of bytes in said first fixed-size file image.

9. The method of claim 8, wherein said first fixed-size file image includes, for each of said plurality of file images, a checksum.

10. The method of claim 8, further comprising:
for each of said plurality of file images, calculating a checksum.

11. The method claim 10, further comprising:
for each of said plurality of file images, comparing a calculated checksum with said checksum.

12. A computer readable medium having instructions stored thereon for provide a bootable image in RAM to a virtual machine that, when executed by a computer, at least instruct the computer to:
create a file accessible file comprising a first fixed-size file image and a plurality of file images, said first fixed-size file image including a file name and a file size for each of said plurality of file images in said file;
provide, by said privileged domain, as a ramdisk, said file to said virtual machine as a single disk image; and,
extract from said single disk image, by said virtual machine, said plurality of file images based on said file name and said file size for each of said plurality of file images.

13. The computer readable medium of claim 12, wherein the computer is further instructed to:
extract from said single disk image, a first fixed-size file from said single disk image by reading a fixed-size number of bytes from said single disk image, said fixed-size number of bytes corresponding to the number of bytes in said first fixed-size file image.

14. The computer readable medium of claim 12, wherein said first fixed-size file image includes, for each of said plurality of file images, a checksum.

15. The computer readable medium of claim 12, wherein the computer is further instructed to:
for each of said plurality of file images, calculating a checksum.

16. The computer readable medium of claim 15, wherein the computer is further instructed to:
for each of said plurality of file images, comparing a calculated checksum with said checksum.
